(19) United States
(12) Patent Application Publication
(10) Pub. No.: US 2010/0022345 A1
(43) Pub. Date: Jan. 28, 2010

(54) AXLE ASSEMBLY

(76) Inventors: HOWARD REASER, Howard, OH (US); Michael F. Ryan, Delaware, OH (US); Benjamin D. Peverly, Howard, OH (US)

Correspondence Address: MARSHALL & MELHORN, LLC;Attention: Stephen P. Evans, Four Seagate - 8th Floor, Toledo, OH, 43604, US

(21) Appl. No.: 12/179,060

(22) Filed: Jul. 24, 2008

(51) Int. Cl. F16H 48/08

(52) U.S. Cl. 475/241; 475/230

(57) ABSTRACT

A drive assembly and method of braking the assembly is disclosed. The assembly has a first clutch pack that selectively brakes a driven shaft. The braking torque is transmitted to a second clutch pack in a differential where it can be distributed equally or unequally between two axle half shafts.

### FIELD OF THE INVENTION

The present invention relates to an axle assembly and more particularly to an axle assembly with a braking feature.

### BACKGROUND OF THE INVENTION

Various devices for braking a vehicle are known. The devices may be located at the wheels for frictionally braking the wheels, or within the driveline of the vehicle for braking some structure within the driveline and thus the wheels as well.

The prior art devices, however, suffer from several disadvantages. For example, one significant disadvantage of the prior art devices is that they cannot brake the axle half shafts of a vehicle both equally and unequally relatively simply and inexpensively. Thus, it would be advantageous for a device to be able to selectively brake both axle half shafts in an equal and unequal manner with a device that is relatively simple and inexpensive.

### SUMMARY OF THE INVENTION

The present invention comprises a shaft having rotors of a first clutch pack attached thereto. A ball ramp is located in contact with the first clutch pack to selectively compress the rotors in first clutch pack and brake the shaft. A gear, attached to the shaft, transmits a braking force to a differential. The differential has a second clutch pack located therein. The second clutch pack permits equal and unequal distribution of brake torque to the axle half shafts connected to the differential.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1A is a plan view of a partial cutaway of one embodiment of an axle assembly;

FIG. 1B is an end view of the device depicted in FIG. 1A;

FIG. 2 depicts certain components of the assembly depicted in FIG. 1;

FIG. 3 depicts one mode of operation of the components depicted in FIG. 2;

FIG. 4 depicts another mode of operation of the components depicted in FIG. 2;

FIG. 5A is a schematic representation of a portion of the present invention; and

FIG. 5B is a schematic representation of a sectional view along line 5B-5B of FIG. 5A.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

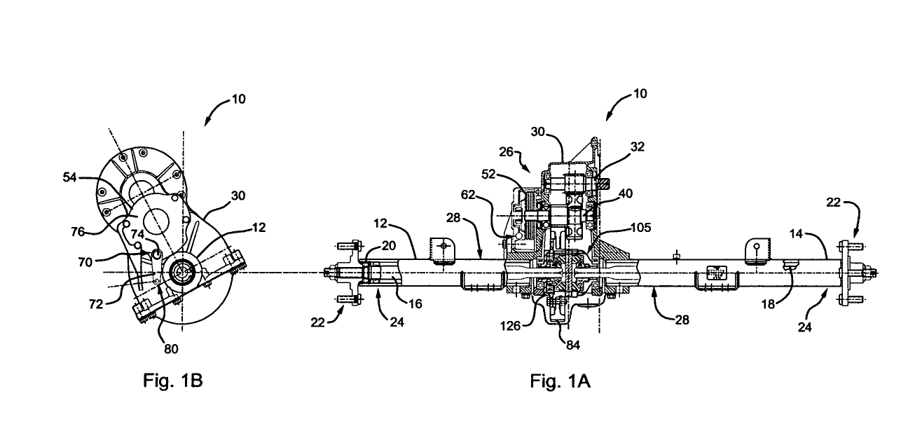

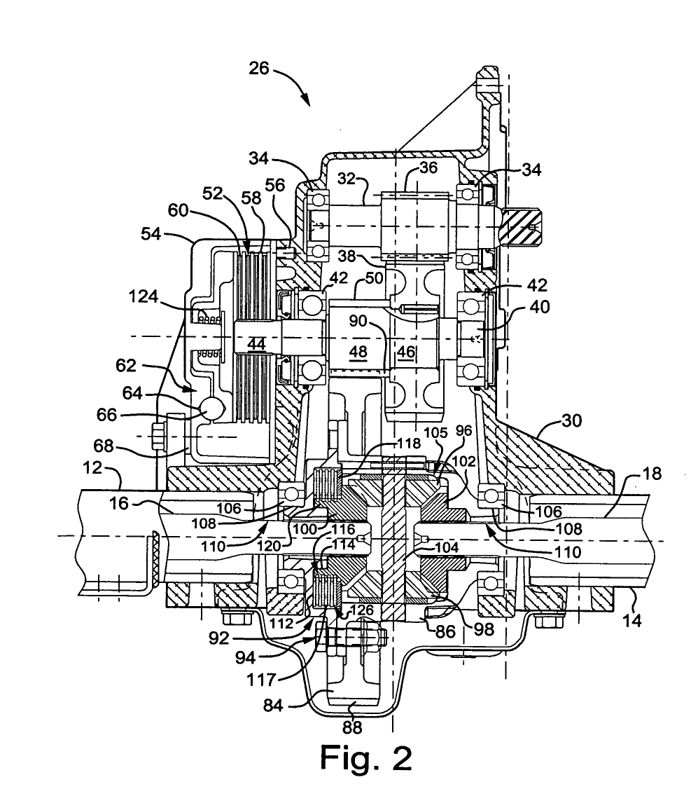

Turning now to FIGS. 1 and 2, one embodiment of a drive system 10 of the present invention is depicted. The drive system 10 comprises a first axle half shaft housing 12 and a second axle half shaft housing 14. Rotatably mounted within the housings are a first axle half shaft 16 and a second axle half shaft 18, respectively. At least one set of bearings 20 is located between each axle half shaft 16, 18, and its respective housing 12, 14, to permit the shafts 16, 18, to rotate within the housings 12, 14. A wheel end 22 is mounted at the outboard end portion 24 of each axle 16, 18 for rotation therewith.

The drive system 10 also comprises a drive assembly 26 mounted adjacent the inboard end portions 28 of each axle 16, 18. The drive assembly 26 comprises a transaxle housing 30. The transaxle housing 30 has rotatably mounted therein a drive shaft 32. The drive shaft 32 may be rotatably driven by any input, such as a propeller shaft (not shown) from a prime mover, such as an internal combustion engine or electric motor (not shown). The drive shaft 32 is mounted for rotation within the housing 30 by bearings 34 located between the shaft 32 and the housing 30.

The drive shaft 32 has a gear 36 that is directly meshed with a gear 38 on a driven shaft 40, also within the transaxle housing 30. The driven gear 38 is mounted for rotation within the transaxle housing 30 by at least two bearings 42. The driven gear 38 has a first end portion 44, a second end portion 46 and an intermediate portion 48 between the end portions 44, 46.

The second end portion 46 has the meshed gear 38. Immediately adjacent the meshed gear 38 is an intermediate gear 50. Adjacent, but outboard of, the intermediate gear 50 is a first clutch pack 52.

The first clutch pack 52 is located outside of the transaxle housing 30 in a clutch pack housing 54 that is attached to the transaxle housing 30, such as by mechanical fasteners 56. The first clutch pack 52 comprises a plurality of stators 58 and rotors 60. The rotors 60 are splined to the driven shaft 40 for rotation therewith and for axial movement there along. The stators 58 are fixedly attached to the transaxle housing 30.

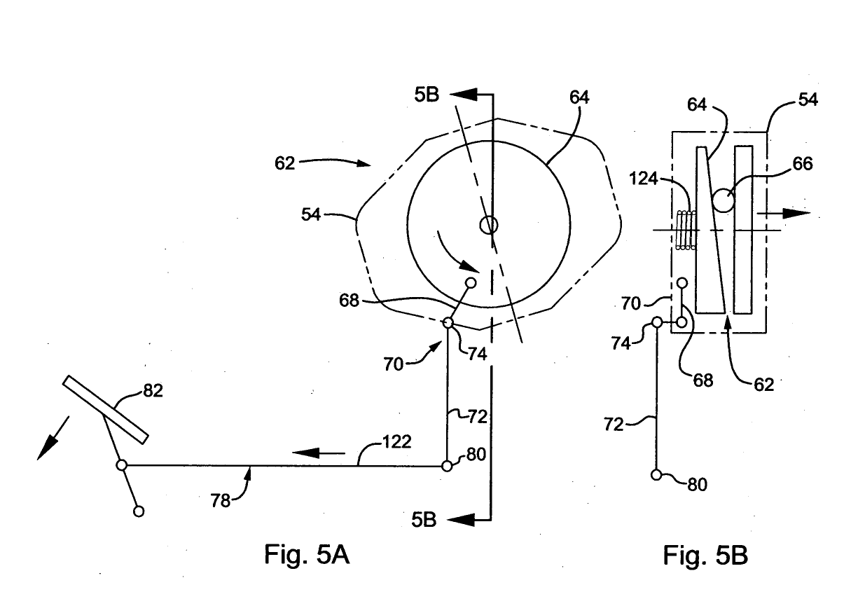

A ball ramp 62 is located immediately outboard of said driven shaft 40 and the first clutch pack 52. As schematically depicted in FIG. 5B, the ball ramp 62 comprises at least one ramp 64 with at least one ball 66 movable along and within the ramp 64. Preferably, two ramps are provided with two balls moveable along and within their respective ramps.

Looking now at FIG. 5B, a brake actuator rod 68 is connected to the ball ramp 62. A first end 70 of a lever arm 72 is connected to the brake actuator rod 68, as seen in both FIGS. 5A and 5B. The lever arm 72 pivots about a mounting point 74 (See FIG. 1B) located on an outside surface of the first clutch pack housing 54. A cable assembly 78 is attached to a second end 80 of the fever arm 72. The cable assembly 78 connects the lever arm 72 with a brake pedal 82 in an operator's compartment of a vehicle (not shown).

Turning now to FIG. 2, the intermediate gear 50 is directly meshed with a ring gear 84 on a differential case 86. The teeth 88 of the ring gear 84 extend directly radially outward from the differential case 86 to engage with the teeth 90 of the intermediate gear 50.

The ring gear 84 may be attached to the differential case 86 in any manner including welding and/or mechanical fasteners. As best seen in FIG. 2, the ring gear 84 is secured to an outer surface 92 of the differential case 86 with mechanical fasteners 94.

The differential case 86 houses at least one pinion gear, a spider shaft and at least one side gear. In the preferred depicted embodiment, the differential case 86 has two pinion gears 96, 98 meshed with two side gears 100, 102 where the pinion gears 96, 98 are connected by a spider shaft 104 to form a differential 105.

The differential case 86 is mounted for rotation within the transaxle housing 30 by at least two bearings 106. Preferably, the bearings 106 sit in bearing seats 108 integrally formed with the outermost axial portions 110 of the differential case 86.

An interior surface 112 of the differential case 86 defines a second clutch pack groove 114. Preferably, a plurality of friction disks 116, a plurality of reaction plates 117 and a biasing member 118 are located within the second clutch pack groove 114. At least a portion 120 of one of the side gears 100 may also be located within the second clutch pack groove 114. The plurality of friction disks 116 are splined for axial movement along one of the side gears 100.

A biasing member 118, such as a conical spring washer, biases the plurality of friction disks 116 and the reaction plates 117 against one another and the interior surface 112 of the differential case 86.

The side gears 100, 102 are splined to the axle half shafts 16, 18 to impart rotational motion from the side gears 100, 102 to the shafts 16, 18.

A method of utilizing the invention described above begins with the operator engaging the brake pedal 82 in the operator's compartment of the vehicle. The brake pedal 82 is attached to the cable assembly 78. When the pedal 82 is depressed, a cable 122 in the assembly 78 pulls on the pivoting lever arm 72, causing it to rotate. The lever arm 72 pivots about the mounting point 74 on the first clutch pack housing 54. When the lever arm 72 pivots about point 74, the lever arm 72 pulls on the brake actuator rod 68. As tension is applied to the brake actuator rod 68, the ball ramp 62 rotates about the center of the driven shaft 40. Rotation of the ball ramp 62 forces the balls 66 within the ball ramp 62 up their respective ramps 64. This action forces the ball ramp 62 apart resulting in an axial movement of the ball ramp 62.

The axial movement of the ball ramp 62 compresses the first clutch pack 52 since the two are located in direct contact with one another. The compression of the first clutch pack 52 causes friction to develop between the stators 58 and rotors 60 in the clutch pack 52. A predetermined amount of axial movement of the ball ramp 62 results in a predetermined amount of friction in the first clutch pack 52 which reduces and then stops the rotation of the rotors 60 with respect to the stators 58. The rotors 60, being attached to the driven shaft 40, prevent the shaft 40 from turning.

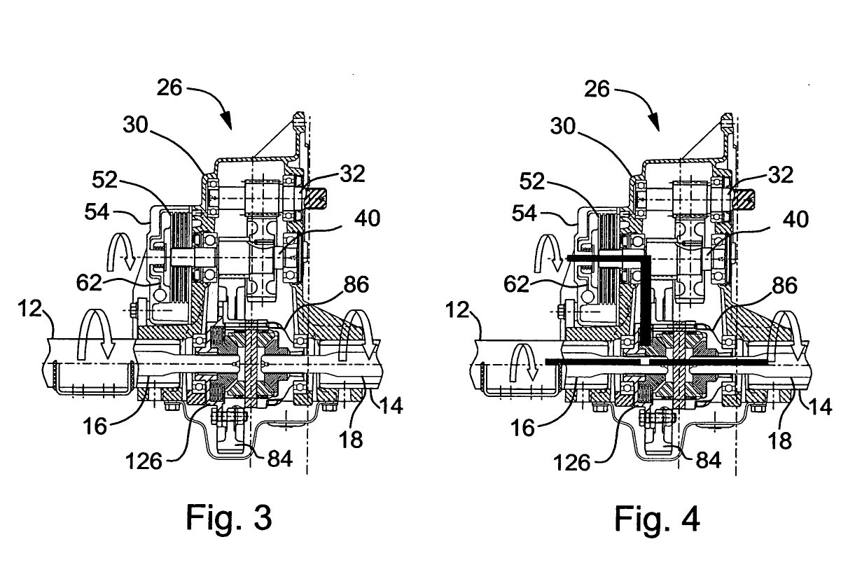

It can be appreciated that when the driven shaft 40 is no longer providing a rotational force to the ring gear 84 secured to the differential case 86, no rotational force will be transmitted to the axle half shafts 16, 18, thus effectively braking the vehicle. When there is no relative motion between the axle half shafts 16, 18, an equal braking torque is applied to the axle half shafts 16, 18 as shown in FIG. 3.

When the brake pedal 82 is not deflected beyond a predetermined point or when it is released, a spring 124 biases the actuator rod 68 back into its original position. This causes the ball ramp 62 to move axially away from the first clutch pack 52, which reduces the compressive force on the first clutch pack 52. With the compressive force reduced or eliminated, the frictional force between the stators 58 and the rotors 60 is reduced or eliminated permitting the rotors 60 to rotate with respect to the stators 58.

A second clutch pack 126 is located within the differential case 86. The second clutch pack 126 is comprised of the friction disks 116, the reaction plates 117 and the biasing member 118. The biasing member 118 compresses the friction disks 116 and the reaction plates 117 against one another and against the interior surface 112 of the differential case 86. Thus, it can be appreciated that the friction disks 116 and reaction plates 117 are typically preloaded in compression by the biasing member 118.

Each of the friction disks 116 are splined for axial movement along one side gear 100 and the disks 116 rotate with the side gear 100, differential case 86 and ring gear 84 as long as both axle half shafts 16, 18 are rotating at the same speed. If a wheel and its associated tire attached to one of the axle half shafts 16 or 18 begins to rotate faster than the other tire/wheel/axle half shaft, such as in a turn, the disks 116 and plates 117 resist this relative rotation. The resistance is provided by the biasing member 118 compressing the disks 116 and the plates 117 together to develop friction between the disks 116 and the plates 117. It can therefore be appreciated that the stiffness of the biasing member 118 and the friction between the disks 116 and the plates 117 determines how much torque is required to produce relative motion of the axle half shafts 16, 18.

Based on the foregoing, it can also therefore be appreciated that the second clutch pack 112 permits unequal braking torque to be supplied to the two axle half shafts 16, 18. Thus, when a braking force is applied to the driven shaft 40 via the first clutch pack 52, the braking force can be varied through the second clutch pack 126 so that the two different braking forces can be applied to each axle half shaft 16, 18 and thus the wheels and tires connected to them, as shown in FIG. 4.

Varying the torque bias between the shafts 16, 18, and thus the wheels/tires, is distinctly advantageous when one drive wheel is on a slippery surface with a low coefficient of friction and the other wheel has good traction as the braking torque required to stop the vehicle can be supplied to the wheel with good traction.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A drive assembly, comprising:
a driven shaft having a first end portion and a second end portion opposite said first end portion, a driven gear being fixed to said second end portion;
a first clutch pack comprised of a plurality of stators and rotors, wherein said rotors are splined to said driven shaft and said stators are non-rotatably attached to a housing for said first clutch pack;
a ball ramp connected to said first clutch pack on said first end portion of said driven shaft, said ball ramp being selectively moveable in the axial direction with respect to said driven shaft for selectively compressing said first clutch pack;
a ring gear meshed with said driven shaft gear, said ring gear mounted to a differential case;
a second clutch pack housed within said differential case, said second clutch pack having a plurality of friction disks, a plurality of reaction plates and a biasing member; and
at least one pinion gear and at least one side gear located in said differential case, said plurality of friction disks being splined to said at least one side gear;
wherein said biasing member biases said plurality of friction disks and disks together and into an inner surface of said differential case.

2. The drive assembly of claim 1, wherein a transaxle housing encloses said driven shaft, said ring gear, and said differential case.

3. The drive assembly of claim 2, wherein said driven shaft and a drive shaft are separately rotatably mounted within said transaxle housing, said drive shaft comprising a drive gear in meshed engagement with said driven gear on said second end portion of said driven shaft.

4. The drive assembly of claim 1, wherein an intermediate gear is located between said driven gear and said first clutch pack on said driven shaft.

5. The drive assembly of claim 2, wherein said housing for said first clutch pack is attached to said transaxle housing.

6. The drive assembly of claim 1 further comprising a pivotable brake actuator rod, wherein a spring urges said rod in one direction.

7. The drive assembly of claim 1, wherein said ring gear has teeth that extend radially away from said differential case to mesh with said intermediate gear.

8. A method of braking a drive assembly, comprising:
providing a rotatable shaft having a plurality of rotors within a first clutch pack on one end portion of said shaft and an intermediate gear adjacent said first clutch pack;
providing a plurality of stators alternating with said rotors, said stators being fixed to a first clutch pack housing;
selectively braking said rotatable shaft by rotationally and axially moving a ball ramp connected to said first clutch pack to axially compress said first clutch pack;
rotating a ring gear on a differential case through its connection with said intermediate gear;
providing a second clutch pack and a differential both within said differential case to selectively brake one or both of a first axle half shaft and a second axle half shaft connected to said differential.

9. The method of claim 8, wherein said rotors are splined to said shaft for axial movement with respect thereto.

10. The method of claim 8, wherein a lever arm pivots about a mounting point on an outer surface of said first clutch pack housing to rotate a brake actuator rod in a first direction, said brake actuator rod rotating said ball ramp about an axis of said shaft resulting in axial movement of said ball ramp along said shaft.

11. The method of claim 8, wherein said first clutch pack selectively locks said shaft to prevent rotation thereof.

12. The method of claim 10, wherein said brake actuator rod is biased in a second direction, opposite said first direction, causing said ball ramp to move axially away from said first clutch pack and permitting said rotors to rotate relative to said stators.

13. The method of claim 8, wherein said second clutch pack is biased against said differential case by a biasing member so that said second clutch pack rotates said axle half shafts at substantially the same rate.

14. The method of claim 13, wherein the predetermined stiffness in said biasing member and the predetermined friction between friction disks and reaction plates in said second clutch pack determines the torque required to permit relative motion between the disks and the plates.

15. The method of claim 9, wherein when said axle half shafts rotate at different rates, braking torque from said first clutch pack is provided to the slower of the two axle half shafts via the second clutch pack.

16. A drive assembly, comprising:
two axle half shafts connected to a differential comprising two side gears, two pinion gears, a spider shaft and a differential clutch pack all located within a differential case,
a ring gear connected to an outside surface of said differential case;
a driven shaft having a clutch pack mounted about a first end portion of said shaft and a gear mounted for rotation on said shaft; and
an axially movable ball ramp outboard of said clutch pack for selective compression of said clutch pack.

17. The drive assembly of claim 16, wherein said gear on said driven shaft is meshed with said ring gear on said differential case so that said ring gear is inboard of said clutch pack on said driven shaft.

18. The drive assembly of claim 16, wherein a biasing member biases said differential clutch pack into an interior surface of said differential case.

19. The drive assembly of claim 17, wherein said differential clutch pack comprises friction disks splined for axial movement along a side gear.

20. A method of braking a drive assembly, comprising:
utilizing a first clutch pack on a driven shaft to selectively brake the shaft;
transmitting braking torque from said driven shaft to a differential case; and
utilizing a second clutch pack located within said differential case to selectively and unequally distribute the braking torque to a first axle half shaft and a second axle half shaft.

21. The method of claim 20, wherein selective axial movement of a ball ramp in direct contact with said first clutch pack compresses said first clutch pack to brake the driven shaft.

22. The method of claim 20, wherein friction between a plurality of friction disks and a plurality of reaction plates and the spring force of a biasing member located within said second clutch pack which forces said disks and said plates together determines when braking torque is unequally applied to said axle half shafts.
